(19) United States
(12) Patent Application Publication
(10) Pub. No.: US 2016/0019320 A1
(43) Pub. Date: Jan. 21, 2016

(54) THREE-DIMENSIONAL COMPUTER-AIDED DIAGNOSIS APPARATUS AND METHOD BASED ON DIMENSION REDUCTION

(71) Applicant: Samsung Electronics Co., Ltd., Suwon-si (KR)

(72) Inventors: Ye Hoon KIM, Seoul (KR); Yeong Kyeong Seong, Yongin-si (KR)

(73) Assignee: SAMSUNG ELECTRONICS CO., LTD., Suwon-si (KR)

(21) Appl. No.: 14/802,158

(22) Filed: Jul. 17, 2015

(30) Foreign Application Priority Data
Jul. 18, 2014 (KR) 10-2014-0091172

(51) Int. Cl. G06F 17/50

(52) U.S. Cl. CPC G06F 17/50

(57) ABSTRACT

A Three-Dimensional (3D) Computer-Aided Diagnosis (CAD) apparatus and method. The 3D CAD apparatus includes: a dimension reducer configured to reduce a dimension of a 3D volume data to generate at least one dimension-reduced image, and a diagnosis component configured to detect a lesion in a 3D volume based on the at least one dimension-reduced image and to diagnose the detected lesion.

### CROSS-REFERENCE TO RELATED APPLICATION(S)

This application claims priority from Korean Patent Application No. 10-2014-0091172, filed on Jul. 18, 2014, in the Korean Intellectual Property Office, the entire disclosure of which is incorporated herein by reference for all purposes.

### BACKGROUND

1. Field

The following description generally relates to a technique for analyzing medical images, and more particularly to a Three-Dimensional (3D) Computer-Cided Aiagnosis (CAD) apparatus and method based on dimension reduction.

2. Description of Related Art

A Computer-Aided Diagnosis (CAD) system refers to a system that may analyze medical images, such as ultrasonic images, and may mark abnormal regions in the medical images based on the analysis in order to assist doctors to diagnose diseases. The CAD system may reduce uncertainty in diagnosis inevitably caused by the limited identification ability of humans, and may relieve doctors of the heavy tasks of evaluating each and every medical image.

In the case of a Three-Dimensional (3D) CAD system that processes 3D image data, such as image data from 3D ultrasonic imaging, Magnetic Resonance Imaging (MRI), Computed Tomography (CT), or the like, a more significant amount of information or data may be required to be stored, computed, and processed, relative to a Two-Dimensional (2D) CAD system that processes 2D image data. As a result, the 3D CAD system may be slower in computing or processing the 3D image data and at the same time the 3D CAD system may require much more memory relative to the requirements of the 2D CAD system.

Accordingly, there is a need for a method of rapidly detecting or diagnosing lesions using 3D image data while maintaining accuracy.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed is a 3D computer-aided diagnosis apparatus and method based on dimension reduction.

In one general aspect, there is provided a Three-Dimensional (3D) Computer-Aided Diagnosis (CAD) apparatus, including a dimension reducer configured to reduce a dimension of a 3D volume data to generate at least one dimension-reduced image, and a diagnosis component configured to detect a lesion in a 3D volume based on the at least one dimension-reduced image and to diagnose the detected lesion.

The dimension reducer may reduce the dimension of the 3D volume data in a direction perpendicular to a cross-section of the 3D volume.

The dimension reducer may reduce the dimension of the 3D volume data by using one of Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), and Independent Component Analysis (ICA).

The diagnosis component may include a first detector that may be configured to detect the lesion from the at least one dimension-reduced image, and a second detector that may be configured to detect the lesion in the 3D volume by combining the detection result.

With respect to the at least one dimension-reduced image, the first detector may generate bounding boxes that represent locations and sizes of lesions in each dimension-reduced images, and the second detector may combine the generated bounding boxes to generate a 3D cube that represents a location and size of the lesion in the 3D volume.

The diagnosis component may further include a first diagnosis component that may be configured to diagnose the lesion detected from the at least one dimension-reduced image, and a second diagnosis component that may be configured to diagnose the lesion in the 3D volume based on a combination of the diagnosis results.

The diagnosis component may include a similar slice image scanner that may be configured to scan a slice image that is most similar to the at least one dimension-reduced image, a first detector that may be configured to detect a lesion from the similar slice image, and a second detector that may be configured to track the detected lesion in slice image frames that are previous and subsequent to the similar slice image, so as to detect the lesion in the 3D volume.

The diagnosis component may further include a lesion diagnosis component that may be configured to diagnose the lesion detected from the similar slice image, and based on the diagnosis, may be configured to diagnose the lesion in the 3D volume.

The diagnosis component may include a first detector that may be configured to detect the lesion from the at least one dimension-reduced image, a first dimension reducer that may be configured to determine a first location of the lesion in the 3D volume based on the detection and to reduce a dimension of the 3D volume data that corresponds to the first location, and a second detector that may configured to detect a lesion from an image generated by reducing the dimension of the 3D volume data that corresponds to the first location, and based on the detection, may be configured to detect the lesion in the 3D volume.

The diagnosis component may further include a lesion diagnosis component that may be configured to diagnose the lesion detected from the at least one dimension-reduced image, and based on the diagnosis, may be configured to diagnose the lesion in the 3D volume.

There is also provided a 3D CAD method, including reducing a dimension of a 3D volume data to generate at least one dimension-reduced image, detecting a lesion in a 3D volume based on the at least one dimension-reduced image, and diagnosing the detected lesion.

The generating of the at least one dimension-reduced image may include reducing the dimension of the 3D volume data in a direction perpendicular to a cross-section of the 3D volume.

The generating of the at least one dimension-reduced image may include reducing the dimension of the 3D volume data by using one of Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), and Independent Component Analysis (ICA).

The detecting may include detecting the lesion from the at least one dimension-reduced image, and detecting the lesion in the 3D volume by combining the detection result.

The detecting of the at least one dimension-reduced image may include, with respect to the at least one dimension-reduced image, generating bounding boxes that represent locations and sizes of lesions in each dimension-reduced images, and combining the generated bounding boxes to generate a 3D cube that represents a location and size of the lesion in the 3D volume.

The diagnosing may include diagnosing the lesion detected from the at least one dimension-reduced image, and diagnosing the lesion in the 3D volume based on a combination of the diagnosis results.

The detecting may include scanning a slice image that is most similar to the at least one dimension-reduced image, detecting a lesion from the similar slice image, and tracking the detected lesion in slice image frames that are previous and subsequent to the similar slice image, so as to detect the lesion in the 3D volume.

The diagnosing may include diagnosing the lesion detected from the similar slice image, and based on the diagnosis, diagnosing the lesion in the 3D volume.

The detecting may include detecting the lesion from the at least one dimension-reduced image, determining a first location of the lesion in the 3D volume based on the detection and reducing a dimension of the 3D volume data that corresponds to the first location, and detecting a lesion from an image generated by reducing the dimension of the 3D volume data that corresponds to the first location, and based on the detection, detecting the lesion in the 3D volume.

The diagnosing may include diagnosing the lesion detected from the at least one dimension-reduced image, and based on the diagnosis, diagnosing the lesion in the 3D volume.

Other features and aspects will be apparent from the following detailed description, the drawings, and the claims.

### BRIEF DESCRIPTION OF THE DRAWINGS

FIG. 1 is a block diagram illustrating an aspect of a Three-Dimensional (3D) Computer-Aided Diagnosis (CAD) apparatus.

FIG. 2 is a block diagram explaining dimension reduction according to an aspect.

FIG. 3 is a block diagram illustrating an aspect of a diagnosis component illustrated in FIG. 1.

FIGS. 4A and 4B are diagrams explaining an operation of detecting a lesion from a 3D volume image by the diagnosis component in FIG. 3.

FIG. 5 is a block diagram illustrating another aspect of the diagnosis component illustrated in FIG. 1.

FIG. 6 is a diagram explaining an operation of detecting a lesion from a 3D volume image by the diagnosis component in FIG. 5.

FIG. 7 is a block diagram illustrating another aspect of the diagnosis component illustrated in FIG. 1.

FIG. 8 is a diagram explaining an operation of detecting a lesion from a 3D volume image by the diagnosis component in FIG. 7.

FIG. 9 is a flowchart illustrating an aspect of a CAD method.

FIG. 10A is a flowchart illustrating an aspect of detecting a lesion.

FIG. 10B is a flowchart illustrating another aspect of diagnosing a lesion.

FIG. 11A is a flowchart illustrating another aspect of detecting a lesion.

FIG. 11B is a flowchart illustrating another aspect of diagnosing a lesion.

FIG. 12A is a flowchart illustrating yet another aspect of detecting a lesion.

FIG. 12B is a flowchart illustrating yet another aspect of diagnosing a lesion.

Throughout the drawings and the detailed description, unless otherwise described, the same drawing reference numerals will be understood to refer to the same elements, features, and structures. The drawings may not be to scale, and the relative size, proportion, and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that may be well known to one of ordinary skill in the art may be omitted for increased clarity and conciseness.

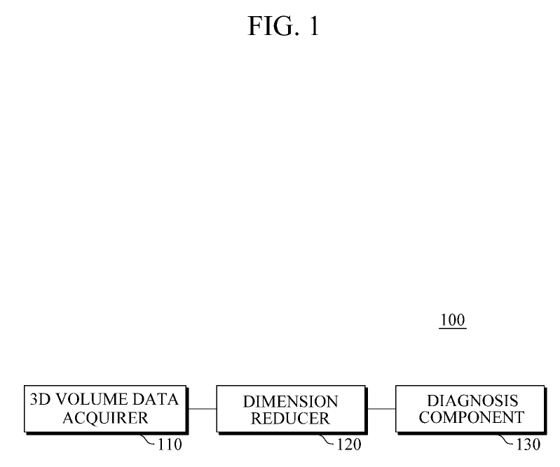

FIG. 1 is a block diagram illustrating an aspect of a Three-Dimensional (3D) Computer-Aided Diagnosis (CAD) apparatus.

The 3D CAD diagnosis apparatus 100 may detect and diagnose a lesion from a 3D volume image by using a dimension reduction method, 2D object detection and classification method, and the like. The 3D Computer-Aided Diagnosis (CAD) diagnosis apparatus 100 may provide support to a doctor during a diagnosis of an image by processing, with a computer, a presence/absence of a lesion (tumor) or other malignant features, a size of the lesion, and a location of the lesion, etc., within a medical image so as to detect the lesion and to provide the detection result to the doctor for diagnosis. In this context, the lesion may refer to a region in an organ or tissue that has suffered damage through injury or disease, such as a wound, ulcer, abscess, tumor, etc.

Referring to FIG. 1, the 3D CAD diagnosis apparatus 100 includes a 3D volume data acquirer 110, a dimension reducer 120, and a diagnosis component 130.

The 3D volume data acquirer 110 may acquire 3D volume data.

In one aspect, the 3D volume data acquirer 110 may receive 3D volume data from an external device. Examples of the external device may include a Computed Tomography (CT) device, a Magnetic Resonance Imaging (MRI) device, a 3D ultrasound imaging device, and the like.

In another aspect, the 3D volume data acquirer 110 may photograph an object to acquire at least one 2D image datum, and may generate 3D volume data based on the acquired 2D image datum. In this case, the acquired 2D datum may be compiled together to generate the 3D volume data. The 3D volume data acquirer 110 may photograph the object using a Computed Tomography (CT) device, a Magnetic Resonance Imaging (MRI) device, an X-ray device, a Positron Emission Tomography (PET) device, a Single Photon Emission Computed Tomography (SPECT) device, an ultrasound imaging device, and the like.

In yet another aspect, the 3D volume data acquirer 110 may receive at least one 2D image datum from an external device to generate 3D volume data based on the received 2D image datum. For example the 3D volume data acquirer 110 may receive a plurality of 2D image data from an external device and may compile the plurality of 2D image data to generate the 3D volume data.

The dimension reducer 120 may reduce the dimension of the acquired 3D volume data to generate at least one dimension reduced 2D image. For example, the dimension reducer 120 may reduce dimension in a direction perpendicular to a cross-section of a 3D volume to generate at least one dimension reduced 2D image. The dimension reducer 120 may use various dimension reduction algorithms, such as Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), Independent Component Analysis (ICA), and the like.

The diagnosis component 130 may detect a lesion from a 3D volume data based on a dimension-reduced image and may diagnose the detected lesion. In this context, the dimension-reduced image may refer to an image that may be resized in order to properly and accurately diagnose the detected legion. The dimension-reduced image may also refer to transforming data in the high-dimensional space to a space of fewer dimensions

In one aspect, the diagnosis component 130 may detect a lesion from each dimension-reduced image, and may combine detection results to determine the locations and sizes of lesions in 3D volume data. Further, the diagnosis component 130 may diagnose a detected lesion based on each dimension-reduced image, and may combine diagnosis results to diagnose lesions in 3D volume data. For example, if a lesion is found on each dimension-reduced image by the diagnosis component 130, the diagnosis component 130 may diagnose the entirety of detected lesion resulting in a diagnosis of the lesion in 3D volume data since the locations and sizes of the lesion in 3D volume data has also been determined by the diagnosis component 130.

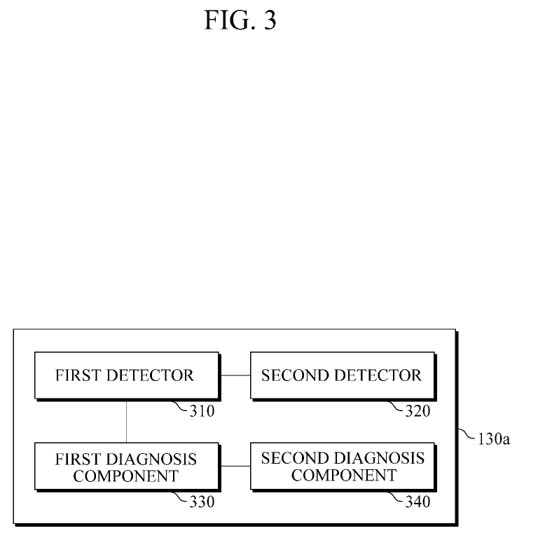

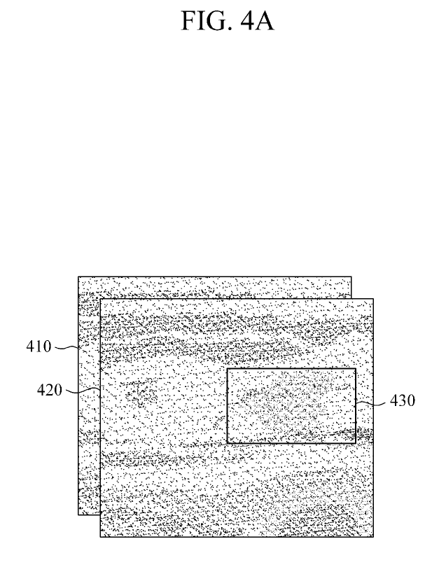

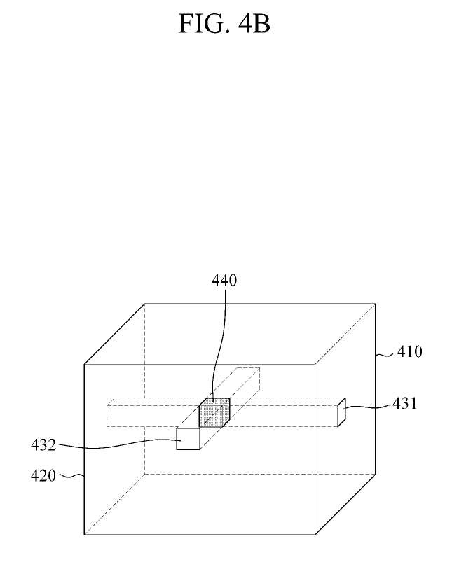

The diagnosis component 130 will be described in further detail with reference to FIGS. 3, 4A, and 4B, as discussed below.

In another aspect, the diagnosis component 130 may scan a slice image that is similar to each dimension-reduced image in order to detect a lesion from the detected slice image. Object tracking may then be performed for slice image frames that are previous to and subsequent to the detected slice image to determine the locations and sized of lesions in 3D volume data. Further, the diagnosis component 130 may diagnose a lesion detected from the scanned slice image so that the diagnosis may be used as a diagnosis result of the lesion in 3D volume data. Otherwise, each slice image frame, for which object tracking is performed, may be diagnosed and the diagnosis results may be combined to obtain a diagnosis result of lesions in 3D volume data.

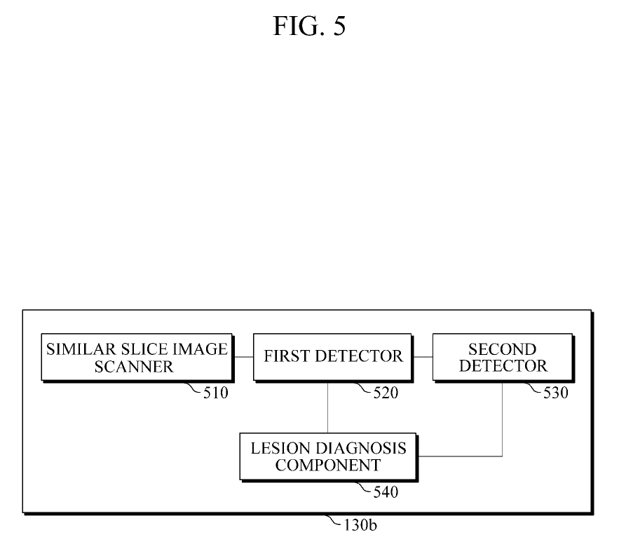

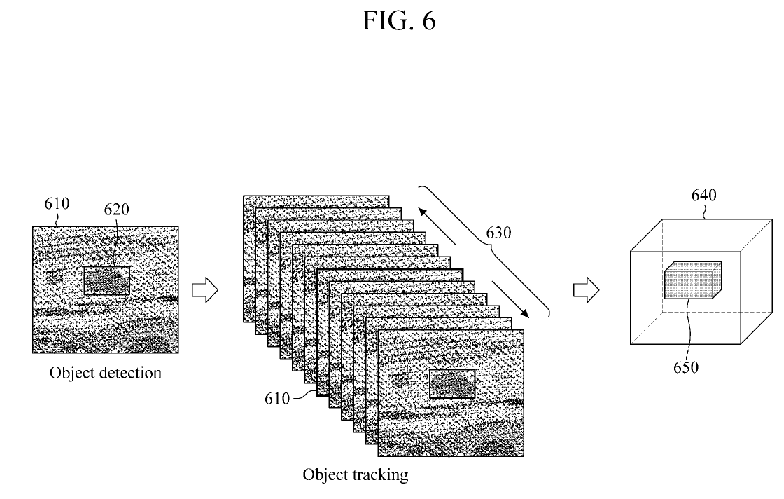

The diagnosis component 130 according to another aspect will be described in detail with reference to FIGS. 5 and 6, as discussed below.

In yet another aspect, the diagnosis component 130 may detect a lesion from a dimension-reduced image generated by the dimension reducer 120. The diagnosis component 130 may also reduce the dimension of a 3D volume data corresponding to the detected lesion in a direction perpendicular to a dimension reduction direction of the dimension-reduced image. Subsequently, the diagnosis component 130 may detect a lesion from an image generated by reducing the dimension of a 3D volume data corresponding to the detected lesion. The location and size of the lesion in 3D volume data based on the detection may then be determined. In addition, the diagnosis component 130 may diagnose a lesion detected from the dimension-reduced image, and may diagnose a lesion in 3D volume data based on the diagnosis.

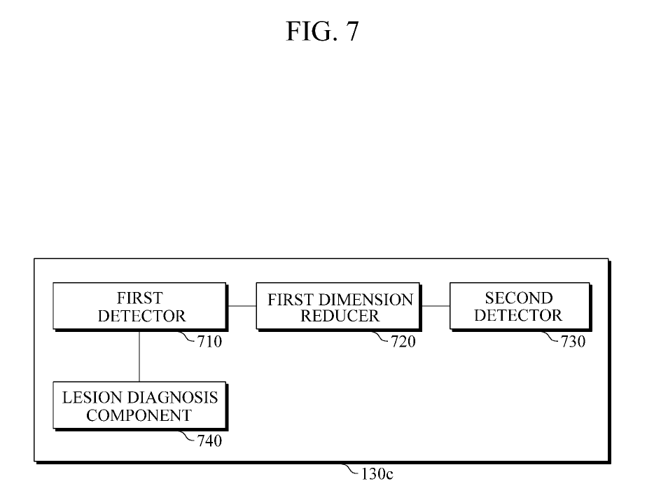

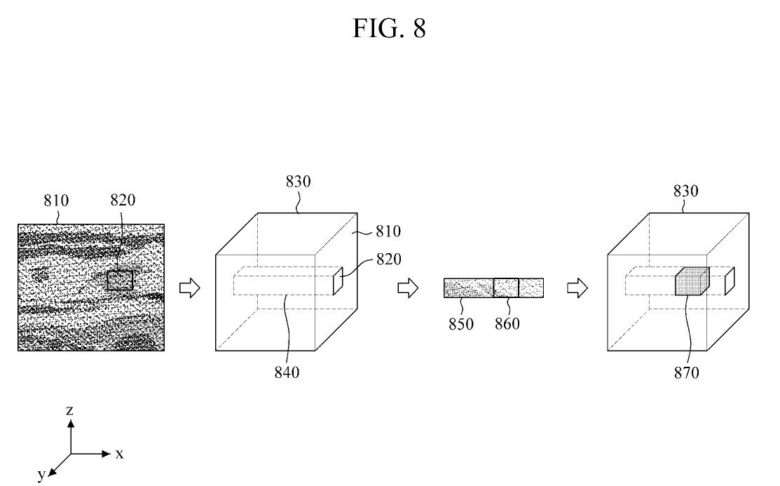

The diagnosis component 130 according to yet another aspect embodiment will be described in detail with reference to FIGS. 7 and 8, as discussed below.

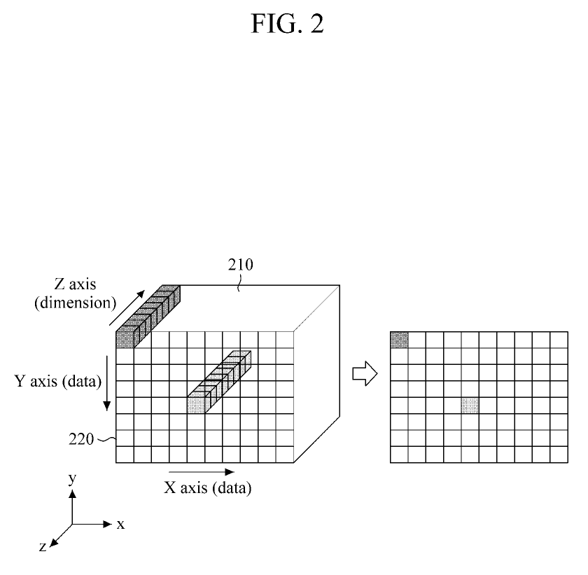

FIG. 2 is a block diagram explaining dimension reduction according to an aspect. More specifically, FIG. 2 is a diagram illustrating an aspect of reducing the dimension of a 3D volume data 210 in a z-axis direction.

Referring to FIG. 2, the dimension reducer 120 reduces the dimension in a z-axis direction by defining voxels of a cross-section 220 corresponding to an x-y plane as data, and by defining voxels of a z-axis that is perpendicular to the cross-section 220 as a dimension. On this context, voxels may refer to each of an array of elements of volume that constitute a notional three-dimensional space, especially each of an array of discrete elements into which a representation of a three-dimensional object is divided. In the aspect, the dimension reducer 120 considers the 3D volume data 210 as an x*y number of data having a z-dimensional vector (vector value =intensity), and reduce the dimension in a z-axis direction. As a result, a 2D image data, in which each pixel has intensity, may be generated as illustrated in FIG. 2.

Hereinafter, the diagnosis component 130 will be described in detail with reference to FIGS. 3, 4A, and 4B, as discussed below.

FIG. 3 is a block diagram illustrating an aspect of a diagnosis component 130 illustrated in FIG. 1. FIGS. 4A and 4B are diagrams explaining an operation of detecting a lesion from a 3D volume image by the diagnosis component 130a in FIG. 3. In description of FIGS. 4A and 4B, the dimension reducer 120 reduces the dimension in an x-axis direction and a y-axis direction to generate two dimension-reduced images (x-axis dimension-reduced image and y-axis dimension-reduced image).

Referring to FIG. 3, the diagnosis component 130a includes a first detector 310, a second detector 320, a first diagnosis component 330, and a second diagnosis component 340.

The first detector 310 may detect a lesion from each dimension-reduced image by using a 2D object detection algorithm. Examples of the 2D object detection algorithm may include AdaBoost, deformable part models (DPM), deep neural network (DNN), convolutional neural network (DNN), sparse coding, and the like, but the 2D object detection algorithm is not limited thereto.

For example, as illustrated in FIG. 4A, the first detector 310 may detect lesions from an x-axis dimension-reduced image 410 and a y-axis dimension-reduced image 420 by using a 2D object detection algorithm, and may generate a bounding box 430 for an area corresponding to the detected lesions.

The second detector 320 may combine results of lesions detected from each dimension-reduced image to detect a lesion in a 3D volume.

For example, as illustrated in FIG. 4B, the second detector 320 may combine a bounding box 431 of the x-axis dimension-reduced image 410, and a bounding box 432 of the y-axis dimension-reduced image 420 to generate a 3D cube 440 that represents the location and size of a lesion in a 3D volume. More specifically, the second detector 320 may determine the location of a lesion in a 3D volume on a y-z plane based on the bounding box 431 of the x-axis dimension-reduced image 410, and the location of a lesion in a 3D volume on a z-x plane based on the bounding box 432 of the y-axis dimension-reduced image 420, and may combine aforementioned values to determine the location and size of a lesion in a 3D volume.

The first diagnosis component 330 may diagnose a lesion detected from each dimension-reduced image by using a 2D object classification algorithm. Examples of the 2D object classification algorithm may include support vector machine (SVM), Decision Tree, Deep Belief Network (DBN), Convolutional Neural Network (DNN), and the like.

The second diagnosis component 340 may diagnose a lesion in a 3D volume based on diagnosis results of each dimension-reduced image. For example, the second diagnosis component 340 may apply a voting algorithm and the like to the diagnosis results of each dimension-reduced image to determine whether a lesion is benign or malignant.

Hereinafter, another aspect of the diagnosis component 130 will be described in detail with reference to FIGS. 5 and 6, as discussed below.

FIG. 5 is a block diagram illustrating another aspect of the diagnosis component 130 illustrated in FIG. 1. FIG. 6 is a diagram explaining an operation of detecting a lesion from a 3D volume image by a diagnosis component 130b in FIG. 5. In description of FIG. 6, the dimension reducer 120 reduces a dimension in an x-axis direction to generate one dimension-reduced image (x-axis dimension-reduced image).

Referring to FIG. 5, the diagnosis component 130B includes a similar slice image scanner 510, a first detector 520, a second detector 520, and a lesion diagnosis component 540.

The similar slice image scanner 510 may scan a slice image that is similar to each dimension-reduced image (hereinafter referred to as a “similar slice image”). The similar slice image scanner 510 may scan a similar slice image by determining a similarity between dimension-reduce images and original slice images that are perpendicular to a dimension reduction direction of the dimension-reduced images.

In one aspect, when determining a similarity between dimension-reduced images and original slice images, the similar slice image scanner 510 may obtain a difference in intensity of each pixel and may detect, as a similar slice image, a slice image that is least different from a dimension-reduced image.

In another aspect, the similar slice image scanner 510 may detect a similar slice image by extracting feature values of each image and measuring a similarity among the extracted feature values.

The first detector 520 may detect a lesion from a similar slice image by using a 2D object detection algorithm. Examples of the 2D object detection algorithm may include AdaBoost, Deformable Part Models (DPM), Deep Neural Network (DNN), Convolutional Neural Network (DNN), Sparse Coding, and the like, but the 2D object detection algorithm is not limited thereto.

For example, as illustrated in FIG. 6, the first detector 520 may detect a lesion from the similar slice image 610 by using a 2D object detection algorithm, and may generate a bounding box 620 for an area corresponding to the detected lesion.

The second detector 530 may track the lesion detected from a similar slice image in slice image frames that are previous to and subsequent to the similar slice image, so as to detect a lesion in a 3D volume. Various object tracking algorithms, such as Mean Shift, CAM shift, and the like, may be used to track lesions.

For example, as illustrated in FIG. 6, the second detector 520 may track the lesion detected from the similar slice image 610 in a slice image frame 630 previous to and subsequent to the similar slice image by using a specific object-tracking algorithm, so as to detect a lesion in a 3D volume 640, and may generate a 3D cube 650 that represents the location and size of the detected lesion.

The lesion diagnosis component 540 may diagnose a lesion detected from a similar slice image by using a 2D object classification algorithm. Examples of the 2D object classification algorithm may include Support Vector Machine (SVM), Decision Tree, Deep Belief Network (DBN), Convolutional Neural Network (DNN), and the like.

The lesion diagnosis component 540 may diagnose a lesion in a 3D volume based on the diagnosis of the similar slice image.

In one aspect, the lesion diagnosis component 540 may consider the diagnosis of the similar slice image to be a diagnosis result of a lesion in a 3D volume.

In another aspect, the lesion diagnosis component 540 may diagnose each slice image frame, which has been tracked for lesions, and may combine the diagnosis with a diagnosis result of the similar slice image by using a voting algorithm and the like, so as to obtain diagnosis results of lesions in a 3D volume.

Hereinafter, another aspect of the diagnosis component 130 will be described in detail with reference to FIGS. 7 and 8, as discussed below.

FIG. 7 is a block diagram illustrating another aspect of a diagnosis component 130 illustrated in FIG. 1. FIG. 8 is a diagram explaining an operation of detecting a lesion from a 3D volume image by a diagnosis component 130c in FIG. 7. In description of FIG. 7 the dimension reducer 120 reduces dimension in an x-axis direction to generate one dimension-reduced image (x-axis dimension-reduced image).

Referring to FIG. 7, the diagnosis component 130c includes a first detector 710, a first dimension reducer 720, a second detector 730, and a lesion diagnosis component 740.

The first detector 710 may detect a lesion from a dimension-reduced image by using a 2D object detection algorithm.

For example, as illustrated in FIG. 8, the first detector 710 may detect a lesion from an x-axis dimension-reduced image 810 by using a 2D object detection algorithm, and may generate a bounding box 820 for an area corresponding to the detected lesion.

The first dimension reducer 720 may determine a first location of a lesion in a 3D volume based on a result of lesion detection from a dimension-reduced image, and may reduce the dimension of a 3D volume data that corresponds to the first location of the lesion in a direction perpendicular to a dimension reduction direction of the dimension-reduced image.

For example, as illustrated in FIG. 8, the first dimension reducer 720 may determine the location of a lesion on a y-z plane based on the bounding box 820 of the x-axis dimension-reduced image 810, and may reduce the dimension of 3D volume data 840 that corresponds to the location of the lesion on the y-z plane in a y-axis direction that is perpendicular to an x-axis direction to generate a dimension-reduced image 850.

By using a 2D object detection algorithm, the second detector 730 may detect a lesion from the dimension-reduced image 850 generated by reducing the dimension by the first dimension reducer 720, and may detect a lesion in a 3D volume based on the detection.

For example, as illustrated in FIG. 8, the second detector 730 may detect a lesion from the dimension-reduced image 850 and may generate a bounding box 860 for an area that corresponds to the detected lesion. More specifically, the second detector 730 may determine the location of a lesion on a z-x plane based on a bounding box 860, and may combine the location of a lesion on a y-z plane with the location on a z-x plane to determine the location and size of a lesion in a 3D volume.

The lesion diagnosis component 740 may diagnose the lesion detected from a dimension-reduced image by using a 2D object classification algorithm, and may combine the diagnosis results to diagnose a lesion in a 3D volume. Examples of the 2D object classification algorithm may include Support Vector Machine (SVM), Decision Tree, Deep Belief Network (DBN), Convolutional Neural Network (DNN), and the like.

In one aspect, the lesion diagnosis component 740 may consider the diagnosis result of the dimension-reduced image 810 to be a diagnosis result of a lesion in a 3D volume.

In another aspect, the lesion diagnosis component 740 may combine the diagnosis result of the dimension-reduced image 810 with the diagnosis result of the dimension-reduced image 850 to obtain a diagnosis result of a lesion in a 3D volume.

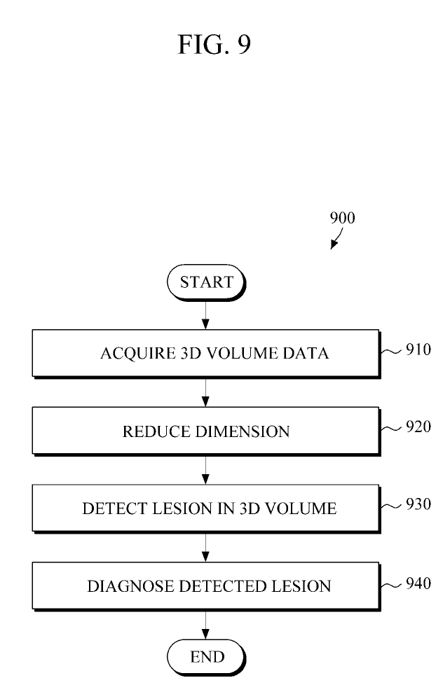

FIG. 9 is a flowchart illustrating an aspect of a computer-aided diagnosis (CAD) method.

Referring to FIG. 9, the CAD method includes acquiring a 3D volume data in 910.

The 3D volume data may include images captured by Computed Tomography (CT) imaging, Magnetic Resonance Imaging, 3D ultrasound imaging, and the like.

Subsequently, the dimension of 3D volume data is reduced to generate at least one 2D dimension-reduced image in 920. For example, the dimension reducer 120 may reduce the dimension of a 3D volume data in a direction perpendicular to a cross-section of a 3D volume. The dimension reducer 120 may use various dimension reduction algorithms, such as Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), Independent Component Analysis (ICA), and the like.

Then, a lesion in a 3D volume is detected based on the dimension-reduced image in 930, and the detected lesion is diagnosed in 940.

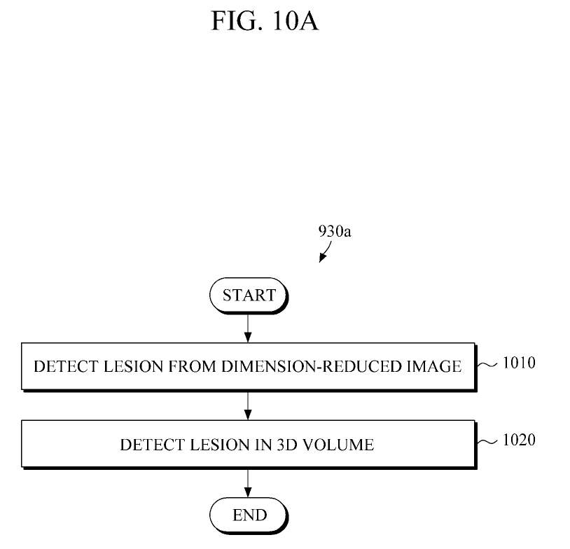

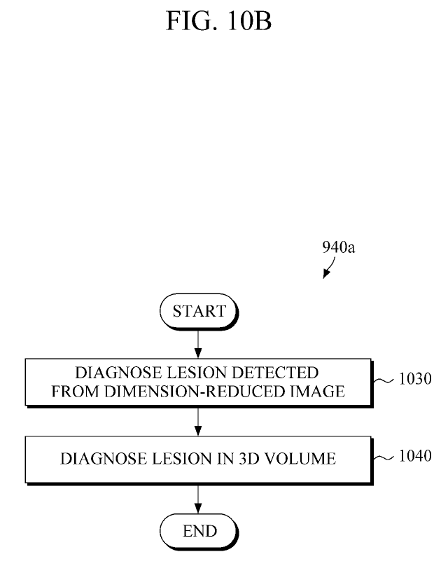

Hereinafter, detection of a lesion in 930 and diagnosis of a lesion in 940 will be described in detail with reference to FIGS. 10A and 10B, as discussed below.

FIG. 10A is a flowchart illustrating an aspect of detecting a lesion in 930. FIG. 10B is a flowchart illustrating an aspect of diagnosing a lesion in 940.

Referring to FIG. 10A, the detection of a lesion in 930a includes detecting a lesion from a dimension-reduced image in 1010. For example, the diagnosis component 130a may detect a lesion from each dimension-reduced image by using a 2D object detection algorithm. Examples of the 2D object detection algorithm may include AdaBoost, Deformable Part Models (DPM), Deep Neural Network (DNN), Convolutional Neural Network (DNN), Sparse Coding, and the like.

Subsequently, detection results in 1010 are combined to detect a lesion in a 3D volume in 1020. Operations 1010 and 1020 are described above with reference to FIGS. 4A and 4B.

Referring to FIG. 10B, the diagnosis of a lesion in 940a includes diagnosing a lesion detected from a dimension-reduced image in 1030. For example, the diagnosis component 130a may diagnose a lesion detected from each dimension-reduced image by using a 2D object classification algorithm. Examples of the 2D object classification algorithm may include Support Vector Machine (SVM), Decision Tree, Deep Belief Network (DBN), Convolutional Neural Network (DNN), and the like.

Then, based on the diagnosis results of each dimension-reduced image, a lesion in a 3D volume is diagnosed in 1040. For example, the diagnosis component 130a may determine whether a lesion is benign or malignant by applying a voting algorithm or the like to the diagnosis results of each dimension-reduced image.

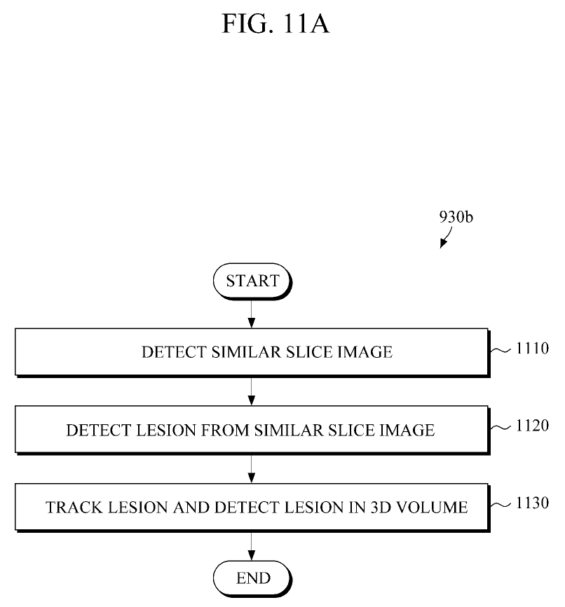

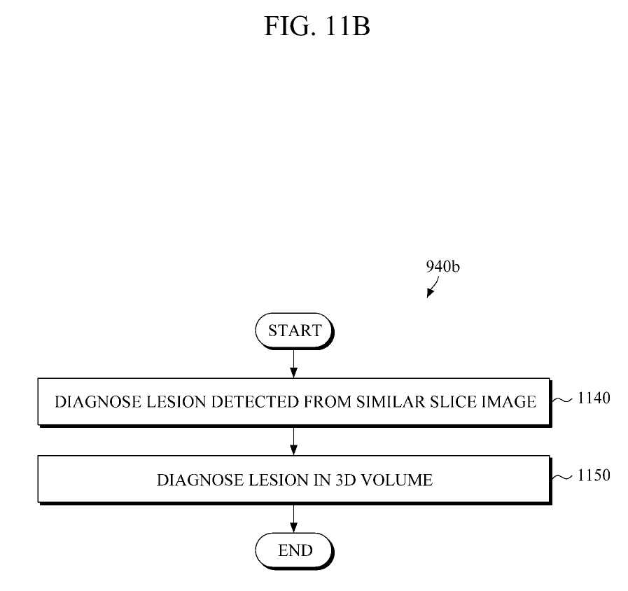

Hereinafter, the detection of a lesion in 930 and the diagnosis of a lesion in 940 according to another aspect will be described in detail with reference to FIGS. 11A and 11B.

FIG. 11A is a flowchart illustrating another aspect of detecting a lesion in 930. FIG. 11B is a flowchart illustrating another aspect of diagnosing a lesion in 940.

Referring to FIG. 11A, the detection of a lesion in 930a includes scanning a similar slice image in 1110 that is similar to a dimension-reduced image. For example, the diagnosis component 130b may scan a similar slice image by determining a similarity between each dimension-reduced image and original slice images that are perpendicular to a dimension-reduction direction of each dimension-reduced image.

Subsequently, a lesion is detected from a scanned similar slice image in 1120. For example, the diagnosis component 130b may detect a lesion from a similar slice image by using a 2D object detection algorithm. Examples of the 2D object detection algorithm may include AdaBoost, Deformable Part Models (DPM), Deep Neural Network (DNN), Convolutional Neural Network (DNN), Sparse Coding, and the like.

Then, a lesion detected from the similar slice image is tracked in slice image frames that are previous to and subsequent to the similar slice image, and based on the tracking result, a lesion is detected in a 3D volume in 1130. For example, the diagnosis component 130b may track a lesion by using various object tracking algorithms, such as Mean shift, CAM shift, and the like.

Operations 1110 to 1130 are described above with reference to FIG. 6, such that detailed descriptions thereof will be omitted.

Referring to FIG. 11B, the diagnosis of a lesion in 940b according to another aspect includes diagnosing a lesion detected from a similar sliced image. For example, the diagnosis component 130b may diagnose a lesion detected from the similar slice image by using a 2D object classification algorithm.

Subsequently, based on the diagnosis results of the similar slice image, a lesion in a 3D volume is diagnosed in 1150. For example, the diagnosis component 130b may consider the diagnosis result of a similar slice image to be a diagnosis result of a lesion in a 3D volume, or may diagnose each slice image frame, which is tracked for a lesion, and may combine the diagnosis results by using a voting algorithm or the like, so as to obtain a diagnosis result of a lesion in a 3D volume.

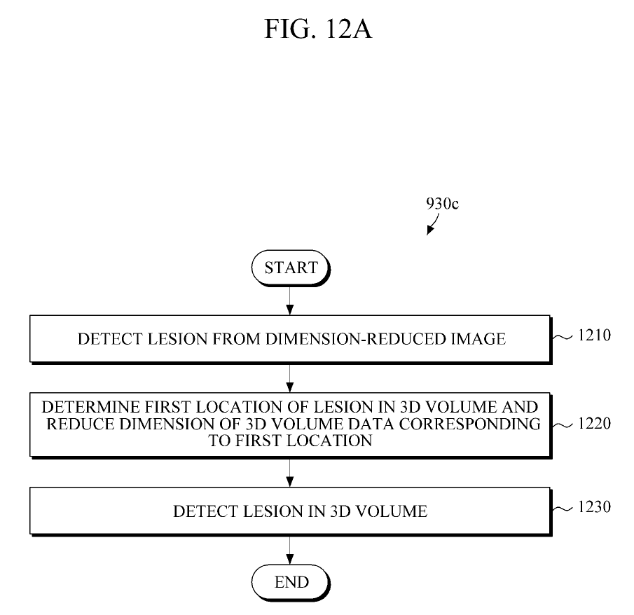

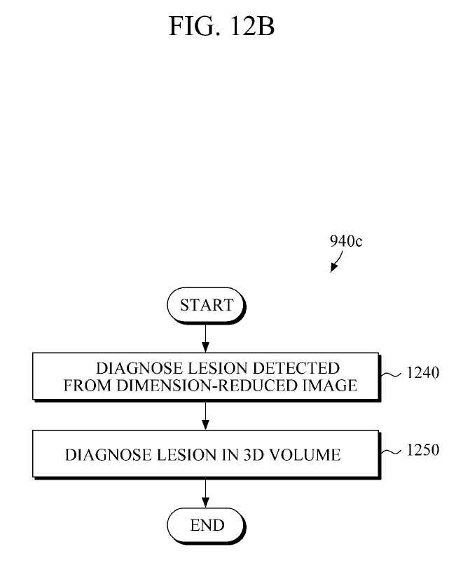

Hereinafter, the detection of a lesion in 930 and the diagnosis of a lesion in 940 according to another aspect will be described in detail with reference to FIGS. 12A and 12B, as discussed below.

FIG. 12A is a flowchart illustrating yet another aspect of detecting a lesion in 930. FIG. 12B is a flowchart illustrating yet another aspect of diagnosing a lesion in 940.

Referring to FIG. 12A, the detection of a lesion in 930c according to another aspect includes detecting a lesion from a dimension-reduced image in 1210. For example, the diagnosis component 130c may detect a lesion from a dimension-reduced image by using a 2D object detection algorithm.

Subsequently, based on the detection of a dimension-reduced image, a first location of a lesion in a 3D volume is determined, and the dimension of a 3D volume data that corresponds to the first location is reduced in a direction perpendicular to a dimension-reduction direction of a dimension-reduced image in 1220.

Then, a lesion is detected from an image generated in 1220, and based on the detection, a lesion in a 3D volume is detected in 1230. Operations 1210 to 1230 are described above with reference to FIG. 8.

Referring to FIG. 12B, the detection of a lesion in 940c includes diagnosing a lesion detected from a dimension-reduced image in 1240. For example, the diagnosis component 130c may diagnose a lesion detected from a dimension-reduced image by using a 2D object classification algorithm.

Then, based on the diagnosis in 1240, a lesion in a 3D volume is diagnosed in 1250.

3D image data may be rapidly analyzed for detection and diagnosis of lesions by reducing a dimension of 3D image data to generate a dimension-reduced image, and by analyzing the generated dimension-reduced image using a 2D object detection and classification method, and the like.

The apparatuses, units, modules, devices, and other components illustrated in FIGS. 1-11, for example, that may perform operations described herein with respect to FIGS. 1-11, for example, are implemented by hardware components. Examples of hardware components include controllers, sensors, memory, drivers, and any other electronic components known to one of ordinary skill in the art. In one example, the hardware components are implemented by one or more processing devices, or processors, or computers. A processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processing device, processor, or computer includes, or is connected to, one or more memories storing instructions or software that are executed by the processing device, processor, or computer and that may control the processing device, processor, or computer to implement one or more methods described herein. Hardware components implemented by a processing device, processor, or computer execute instructions or software, such as an operating system (OS) and one or more software applications that run on the OS, to perform the operations described herein with respect to FIGS. 1-11, for example. The hardware components also access, manipulate, process, create, and store data in response to execution of the instructions or software. For simplicity, the singular term “processing device”, “processor”, or “computer” may be used in the description of the examples described herein, but in other examples multiple processing devices, processors, or computers are used, or a processing device, processor, or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, remote processing environments, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described herein may be performed by a processing device, processor, or a computer as described above executing instructions or software to perform the operations described herein.

Instructions or software to control a processing device, processor, or computer to implement the hardware components and perform the methods as described above may be written as computer programs, code segments, instructions or any combination thereof, for individually or collectively instructing or configuring the processing device, processor, or computer to operate as a machine or special-purpose computer to perform the operations performed by the hardware components and the methods as described above. In one example, the instructions or software include machine code that is directly executed by the processing device, processor, or computer, such as machine code produced by a compiler. In another example, the instructions or software include higher-level code that is executed by the processing device, processor, or computer using an interpreter. Based on the disclosure herein, and after an understanding of the same, programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processing device, processor, or computer to implement the hardware components, such as discussed in any of FIGS. 1-11, and perform the methods as described above in any of FIGS. 1-11, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processing device, processor, or computer so that the processing device, processor, or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processing device, processor, or computer.

What is claimed is:

1. A Three-Dimensional (3D) Computer-Aided Diagnosis (CAD) apparatus, comprising:
a dimension reducer configured to reduce a dimension of a 3D volume data to generate at least one dimension-reduced image; and
a diagnosis component configured to detect a lesion in a 3D volume based on the at least one dimension-reduced image and to diagnose the detected lesion.

2. The apparatus of claim 1, wherein the dimension reducer reduces the dimension of the 3D volume data in a direction perpendicular to a cross-section of the 3D volume.

3. The apparatus of claim 1, wherein the dimension reducer reduces the dimension of the 3D volume data by using one of Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), and Independent Component Analysis (ICA).

4. The apparatus of claim 1, wherein the diagnosis component comprises:
a first detector configured to detect the lesion from the at least one dimension-reduced image; and
a second detector configured to detect the lesion in the 3D volume by combining the detection result.

5. The apparatus of claim 4, wherein:
with respect to the at least one dimension-reduced image, the first detector generates bounding boxes that represent locations and sizes of lesions in each dimension-reduced images; and
the second detector combines the generated bounding boxes to generate a 3D cube that represents a location and size of the lesion in the 3D volume.

6. The apparatus of claim 4, wherein the diagnosis component further comprises:
a first diagnosis component configured to diagnose the lesion detected from the at least one dimension-reduced image; and
a second diagnosis component configured to diagnose the lesion in the 3D volume based on a combination of the diagnosis results.

7. The apparatus of claim 1, wherein the diagnosis component comprises:
a similar slice image scanner configured to scan a slice image that is most similar to the at least one dimension-reduced image;
a first detector configured to detect a lesion from the similar slice image; and
a second detector configured to track the detected lesion in slice image frames that are previous and subsequent to the similar slice image, so as to detect the lesion in the 3D volume.

8. The apparatus of claim 7, wherein the diagnosis component further comprises a lesion diagnosis component configured to diagnose the lesion detected from the similar slice image, and based on the diagnosis, configured to diagnose the lesion in the 3D volume.

9. The apparatus of claim 1, wherein the diagnosis component comprises:
a first detector configured to detect the lesion from the at least one dimension-reduced image;
a first dimension reducer configured to determine a first location of the lesion in the 3D volume based on the detection and to reduce a dimension of the 3D volume data that corresponds to the first location; and
a second detector configured to detect a lesion from an image generated by reducing the dimension of the 3D volume data that corresponds to the first location, and based on the detection, configured to detect the lesion in the 3D volume.

10. The apparatus of claim 9, wherein the diagnosis component further comprises a lesion diagnosis component configured to diagnose the lesion detected from the at least one dimension-reduced image, and based on the diagnosis, configured to diagnose the lesion in the 3D volume.

11. A Three-Dimensional (3D) Computer-Aided Diagnosis (CAD) method, comprising:
reducing a dimension of a 3D volume data to generate at least one dimension-reduced image;
detecting a lesion in a 3D volume based on the at least one dimension-reduced image; and
diagnosing the detected lesion.

12. The method of claim 11, wherein the generating of the at least one dimension-reduced image comprises reducing the dimension of the 3D volume data in a direction perpendicular to a cross-section of the 3D volume.

13. The method of claim 11, wherein the generating of the at least one dimension-reduced image comprises reducing the dimension of the 3D volume data by using one of Principal Component Analysis (PCA), Linear Discriminant Analysis (LDA), Non-negative Matrix Factorization (NMF), Locally Linear Embedding (LLE), Isomap, Locality Preserving Projection (LPP), Unsupervised Discriminant Projection (UDP), Factor Analysis (FA), Singular Value Decomposition (SVD), and Independent Component Analysis (ICA).

14. The method of claim 11, wherein the detecting comprises:
detecting the lesion from the at least one dimension-reduced image; and
detecting the lesion in the 3D volume by combining the detection result.

15. The method of claim 14, wherein:
the detecting of the at least one dimension-reduced image comprises, with respect to the at least one dimension-reduced image, generating bounding boxes that represent locations and sizes of lesions in each dimension-reduced images; and
combining the generated bounding boxes to generate a 3D cube that represents a location and size of the lesion in the 3D volume.

16. The method of claim 14, wherein the diagnosing comprises:
diagnosing the lesion detected from the at least one dimension-reduced image; and
diagnosing the lesion in the 3D volume based on a combination of the diagnosis results.

17. The method of claim 11, wherein the detecting comprises:
scanning a slice image that is most similar to the at least one dimension-reduced image;
detecting a lesion from the similar slice image; and
tracking the detected lesion in slice image frames that are previous and subsequent to the similar slice image, so as to detect the lesion in the 3D volume.

18. The method of claim 17, wherein the diagnosing comprises:
diagnosing the lesion detected from the similar slice image; and
based on the diagnosis, diagnosing the lesion in the 3D volume.

19. The method of claim 11, wherein the detecting comprises:
detecting the lesion from the at least one dimension-reduced image;
determining a first location of the lesion in the 3D volume based on the detection and reducing a dimension of the 3D volume data that corresponds to the first location; and
detecting a lesion from an image generated by reducing the dimension of the 3D volume data that corresponds to the first location, and based on the detection, detecting the lesion in the 3D volume.

20. The method of claim 19, wherein the diagnosing comprises:
diagnosing the lesion detected from the at least one dimension-reduced image; and
based on the diagnosis, diagnosing the lesion in the 3D volume.
